(19) United States
(12) Patent Application Publication
(10) Pub. No.: US 2026/0244530 A1
(43) Pub. Date: Aug. 20, 2026

(54) DETECTION AND CORRECTION OF ERRORS USING LIMITED ERROR CORRECTION DATA

(71) Applicant: Rambus Inc., San Jose, CA (US)

(72) Inventor: Michael Alexander Hamburg, ‘s-Hertogenbosch (NL)

(21) Appl. No.: 18/874,584

(22) PCT Filed: Jun. 13, 2023
(86) PCT No.: PCT/US2023/025223

§ 371 Date: Dec. 12, 2024

Related U.S. Application Data
(60) Provisional application No. 63/351,913, filed on Jun. 14, 2022.

(51) Int. Cl. G06F 11/10

(52) U.S. Cl. CPC G06F 11/1048; G06F 11/1068

(57) ABSTRACT

Aspects and implementations include systems and techniques for efficient detection and correction of errors in stored and communicated data, including obtaining a codeword generated by a computer operation applied to an original codeword that encodes a plurality of symbols, computing, a plurality of syndrome values characterizing a difference between the codeword and the original codeword, identifying a reduced set of error locator polynomials (ELPs), each ELP associated with (i) at least one potential error within a respective group of symbols and (ii) absence of potential errors outside the respective group of symbols, selecting an indicator ELP associated with a corrupted group of symbols having at least one error, and identifying, using the indicator ELP, the corrupted group of symbols.

### RELATED APPLICATIONS

This is a national stage application under 35 U.S.C. 371 of International Application PCT/US2023/025223, filed Jun. 13, 2023, which claims benefit to U.S. Provisional Patent Application No. 63/351,912, filed Jun. 14, 2022, the contents of both aforementioned applications being incorporated by reference in their entirety herein.

### TECHNICAL FIELD

The disclosure pertains to computing applications, more specifically to systems and techniques that improve reliability of recovering data that may be corrupted during data storage, retrieval, and communication, using limited amounts of error correction data.

### BRIEF DESCRIPTION OF THE DRAWINGS

The present disclosure will be understood more fully from the detailed description given below and from the accompanying drawings of various implementations of the disclosure.

FIG. 1 is a block diagram of an example computer system in which implementations of the disclosure may operate.

FIG. 2 is a diagram illustrating operations of efficient lightweight detection of memory errors using reduced error locator polynomials, in accordance with some aspects of the present disclosure.

FIGS. 3A-B are diagrams illustrating operations of key equation solvers that implement lightweight detection of memory fails, in accordance with some aspects of the present disclosure.

FIG. 4 is a flow diagram illustrating an example method of efficient lightweight detection of memory errors using reduced error locator polynomials, in accordance with some implementations of the present disclosure.

FIG. 5 is a flow diagram illustrating an example method of detecting and managing failed memory devices, in accordance with some implementations of the present disclosure.

FIG. 6 depicts a block diagram of an example computer system operating in accordance with one or more aspects of the present disclosure.

### DETAILED DESCRIPTION

Aspects and implementations of the present disclosure are related to systems and techniques that detect failure of memory operations and using limited amounts of error correction information. Error correction (EC) techniques operate by storing data in conjunction with additional EC data that is redundant under ideal conditions, but enables to identify parts of data that are lost in transmission or corrupted during write operations or storing of the data. For example, 32 symbols (e.g., bytes, double-bytes, etc.) of data may be stored in a memory device (or communicated over a network) together with 8 symbols of EC code for the data. In some secure memory systems, 40 symbols of data/EC code may be spread over multiple memory chips, so that a failure of any one chip does not result in irreversible loss of the data. For example, 10 chips may be used to store 32 symbols, with 8 chips storing 4 symbols of data each, and 2 additional chips may be used to store 2 EC symbols. For speed of memory write and read operations, each chip may be accessed using multiple buses (channels), e.g., with 4 (or 2) channels per chip, so that each symbol (or a pair of symbols) is stored and accessed in a respective chip via a separate channel.

Various codes of error correction may be used, including Reed-Solomon (RS) codes, Bose-Chaudhuri-Hocquenghem (BCH) codes, Hamming codes, and the like. More specifically, a message to be stored (or communicated) may include k symbols m₀, m₁ . . . mₖ₋₁ (e.g., k=32 in the above example), each symbol encoding an element of the Galois field GF(2^{q}), e.g., polynomials of order q−1 with the addition (and multiplication) operations defined modulo 2 (bitwise XOR operations) and the multiplication (and division) operations defined modulo a suitably chosen irreducible polynomial of order q (e.g., q=8 for one-byte symbols). For example, the k-symbol message is mapped on the polynomial

$$m ( x ) = {\sum }_{j = 0}^{k - 1} {m}_{j} {x}^{j}$$

in the Galois field GF(2^{q}). To supplement the message with EC data, a generator polynomial may be formed,

$$g ( x ) = {\prod }_{j = 1}^{t} ( x - {a}_{j} ) ,$$

which has t=n−k roots a₁, a₂ . . . aₜ that are typically chosen as powers of some primitive element d of the Galois field, e.g., aⱼ=d^{j}. The message polynomial m(x) may then be multiplied by x^{t} (which can be performed via bit shifting) to make space for t error correction symbols, and the remainder polynomial r(x) of order t resulting from division of m(x)x^{t} by the generator polynomial g(x) may be computed, r(x)=m(x)x^{t} mod g(x). By construction, the combination c(x)=m(x)x^{t}+r(x) is divisible by the generator polynomial g(x) and, therefore, inherits the t roots a₁, a₂ . . . aₜ of the generator polynomial. The combination c(x) represents a codeword of n symbols that are stored in the memory (or communicated over network) in lieu of the k-symbol message m(x).

After the codeword c(x) is stored and then retrieved from the memory (or, in network communications, after the codeword is transmitted and received by a target device), the stored (received) value s(x) of the codeword can be the same as the encoded codeword, s(x)=c(x) (uncorrupted value), or different from the encoded codeword, s(x)≠c(x) (corrupted value). A departure of the stored value s(x) from the encoded codeword c(x) may be quantified by evaluating the polynomial s(x) at each of the roots a₁, a₂ . . . aₜ, resulting in t syndrome values Sⱼ=s(aⱼ), which can be viewed as coefficients of a syndrome polynomial

$$S ( x ) = {\sum }_{j = 0}^{t - 1} {S}_{j + 1} {x}^{j}$$

of order t−1. All zero syndrome values, {Sⱼ}=0, indicate that the stored codeword is the same as the encoded codeword, so that the message m₀, m₁ . . . mₖ₋₁ can be read as k most significant symbols of the codeword.

When some of the syndrome values Sⱼ are nonzero, one or more symbols of the codeword have been corrupted. To identify symbols in which errors are located, an error locator polynomial Λ(x) can be defined. More specifically, if v symbol have errors, the coefficients of the syndrome polynomial may be represented as

$${S}_{j} = {\sum }_{e = 1}^{v} {y}_{e} {X}_{e}^{j} ,$$

where index e enumerates errors, yₑ characterizes the value of the eth error, and error locator Xₑ identifies a location of eth error. For example, if the roots of the generator polynomial are at aⱼ=d^{j}, and eth error is in symbol iₑ, the error locator is Xₑ=dⁱ^{ₑ}. The locations of errors define the error locator polynomial,

$$Λ ( x ) = {\prod }_{e = 1}^{v} ( 1 - {xX}_{e} ) = {\sum }_{l = 0}^{v} {Λ}_{l} {x}^{l}$$

of order v, whose coefficients Λₗ are constrained by the fact that the inverse locators

$${X}_{e}^{- 1}$$

are the roots of the locator polynomial,

$${\sum }_{l = 0}^{v} {Λ}_{l} {X}_{e}^{- l} = 0$$

for all values e. The latter conditions are equivalent to a set of locator constraints

$${\sum }_{l = 0}^{v} {Λ}_{l} {S}_{i + v - l} = 0 , i = 1 ... v .$$

which represents the system of v equations for v unknown coefficients Λ_{l≠0} (since Λ₀=1) with known values Sᵢ₊ᵥ₋ₗ.

Stated equivalently, the locator constraints ensure that the product of the error locator polynomial and the syndrome polynomial,

$$Λ ( x ) S ( x ) = {\sum }_{p = 0}^{v - 1} ( {ω}_{p} {x}^{p} + {ξ}_{p} {x}^{t + p} ) ,$$

includes low powers 1, x, x² . . . x^{v-1} with coefficients

$${ω}_{p} = {\sum }_{l = 0}^{p} {Λ}_{l} {S}_{p - l + 1}$$

and high powers x^{t} . . . x^{t+v-1} with coefficients

$${ξ}_{p} = {\sum }_{l = p - t + 1}^{v} {Λ}_{l} {S}_{p - l + 1} .$$

Yet no middle powers x^{v} . . . x^{t-1} are present in the product Λ(x)S(x), having coefficients that are zero due to the locator constraints. The coefficients of the error locator polynomial Λ₁ . . . Λᵥ, therefore, satisfy the following equation, commonly known as the key equation,

$$Ω ( x ) = Λ ( x ) S ( x ) mod {x}^{t} ,$$

where

$$Ω ( x ) = {\sum }_{p = 0}^{v - 1} {ω}_{p} {x}^{p}$$

is the error-evaluator polynomial of an order no higher than v.

Solving the key equation determines coefficients Λ₁ . . . Λᵥ. Subsequently, the roots

$$\{ {X}_{e}^{- 1} \}$$

of the error location polynomial Λ(x) can be found, e.g., by exhaustive search, the Chien search, etc., and the error locators {Xₑ} can be computed as the reciprocals of the roots. The error values yₑ can then be determined by solving the system of equations,

$${S}_{j} = {\sum }_{e = 1}^{v} {y}_{e} {X}_{e}^{j} , e . g . ,$$

using the Forney algorithm. The error location iₑ (identifying a symbol having eth error) can be determined as the logarithm, iₑ=log_{d} Xₑ. The obtained values yₑ and iₑ can be used to determine the error polynomial,

$$Δ ( x ) = {\sum }_{e = 1}^{v} {y}_{e} {x}^{{i}_{e}}$$

that being added to the stored codeword s(x) recovers the actual codeword, c(x)=s(x)+Δ(x).

The techniques described above allow to identify a failure of any chip during storage of 32 symbols of data (e.g., in 8 chips with 4 symbols stored per chip) if t=8 EC symbols are stored (e.g., in 2 additional chips) in conjunction with the data and are used in techniques of checking and correcting errors in memory, e.g., in Chipkill™ technology. An EC code (40, 32) is then capable of detecting and correcting errors in any 4 (v=t/2=4) of 40 symbols, which can be symbols stored in the same chip. This enables detection of an entire chip failure.

In some applications, however, it can be advantageous to store additional (non-redundant) data in conjunction with the stored message, e.g., a metadata or some other data. For example, one or more additional symbols of data may need to be stored, leaving fewer symbols to store the EC data. For example, if 33 symbols of data are stored, only t=7 EC symbols are available for error detection and correction. An EC code (40, 33), which deploys the techniques described above, has a sub-threshold number (t<8) of EC symbols and can locate and correct only three errors. Therefore, in the instances of a chip failure, this would result in an irreversible loss of data. The existing techniques, e.g., Sudan-Guruswami algorithm, allow sub-threshold error correction, but require substantial processing times (e.g., cycling through all possibilities of errors), which reduces memory access (or communication) bandwidth.

Aspects of the present disclosure address the above noted and other shortcomings of the existing technology by enabling systems and techniques for fast identification of failed memory devices using sub-threshold number of error correction symbols. Error correction may be performed to support memory operations (store and read) in N chips. Each chip may be configured to store L symbols of data, which may be accomplished using L separate channels. Correspondingly, a stored codeword may include n=N×L symbols spread across N chips. In contrast to conventional error correction techniques, which use 2L EC symbols to identify and correct a failure of a given chip (to detect and correct errors in each of L symbols stored in the chip), the disclosed implementations deploy techniques for sub-threshold detection of a failed chip using fewer than 2L symbols, e.g., 2L−η symbols. The remaining k=(N−2)×L+η symbols may be used to store actual message data, and/or or metadata. In one implementation, error labels Xₑ may be assigned to different symbols (channels) in such a way that the error locator polynomial

$$Λ ( x ) = {\prod }_{e = 1}^{L} ( 1 - {xX}_{e} )$$

has a simplified form with a reduced number of degrees of freedom. For example, a conventional algorithm would deploy an error locator polynomial with L coefficients/degrees of freedom (one of the L+1 coefficients being irrelevant due to arbitrary overall scaling). Instead, as provided for in the instant disclosure, identification of a failed memory chip may be successfully performed (in an overwhelming number of cases) using special error labels Xₑ that cause the locator polynomial to have a simplified (reduced) form with one, two, etc., degrees of freedom (free coefficients). For example, the error locator polynomial may have a single parameter β, e.g., Λ_{R}(x)=x^{L}+x+β, Λ_{R}(x)=βx^{L}+x^{L-1}+1, or Λ_{R}(x)=x^{L}+ . . . +βx^{L-p}+ . . . +1, with at least some (e.g., L−1) parameters having certain fixed values (e.g., ones and/or zeros). The reduced error locator polynomial Λ_{R}(x) is capable of detecting a compound failure of up to L symbols stored in any of the N chips, e.g., by determining that the value of the remaining free parameter β is one of the chip labels, β₁ . . . β_{N}, associated with a specific chip. More specifically, once the syndrome polynomial S(x) of order 2L−η is determined to have a non-zero value, the key equation may be solved using the reduced error locator polynomial Λ_{R}(x). In the instances where errors are confined to a single chip, the reduced error locator polynomial Λ_{R}(x) provides a valid solution of the key equation with a specific value β, this value β may be compared with different chip labels βⱼ for identification of the failed memory chip.

Although the reduced error locator polynomial Λ_{R}(x) may be agnostic as to the number of corrupted symbols on the memory chip (e.g., one, two, etc., and up to L symbols), identification of specific corrupted symbols may be performed in conjunction with other techniques. For example, the reduced polynomial-based EC systems and techniques (also referred to as lightweight memory fail detector or simply lightweight detector herein) may be used in conjunction (e.g., in parallel) with more conventional techniques, e.g., iterative EC techniques. The iterative EC decoder techniques may attempt to find v errors using a set of error locator polynomials

$$Λ ( x ) = {\prod }_{e = 1}^{v} ( 1 - {xX}_{e} )$$

of increasing order v that are used to locate iteratively v=1, 2 . . . L/2−η errors (if η is odd, assuming that L is even) or v=1, 2 . . . (L−η)/2 errors (if η is even). In the instances where L/2−η (or (L−η)/2) or fewer errors are identified by the iterative EC decoder, the result of the lightweight detector will be consistent with the iterative EC result as long as all errors are in the same chip. If L/2−η errors are spread across multiple chips, the lightweight detector will be unable to return a meaningful result, again consistent with the iterative EC result.

In the instances where the iterative EC result indicates more than L/2−η (or (L−η)/2) errors, the iterative EC decoder may be unable to identify locations of the errors, including determining whether the errors are confined to a single chip or spread across multiple chips. The lightweight detector, on the other hand, may determine that a specific chip has failed and that no other chips are affected. Finally, in the instances where the iterative EC result indicates more than L/2−η (or (L−η)/2) errors and the lightweight detector does not identify a specific chip, any number of errors may be spread across multiple chips. Accordingly, the system performing the error correction may report errors as uncorrectable.

The advantages of the disclosed techniques include but are not limited to fast and efficient identification of errors using a limited (sub-threshold) number of error correction symbols beyond the Singleton bound. More specifically, the Singleton bound, which applies to certain classes of codes including Reed-Solomon codes, limits ability of L EC symbols to ensure guaranteed recovery of L/2 symbols (rounded down). Conversely, recovery of more than L/2 corrupted symbols (rounded down) with L or fewer EC symbols is not possible with a complete reliability. Such advanced techniques include the Sudan-Guruswami algorithm capable of correcting more than L/2 errors with a high but still imperfect probability. The errors that can be identified using the lightweight detector techniques of the instant disclosure include, but are not limited to, errors that are confined to a particular memory chip, e.g., multi-symbol errors, and total fail of the memory chip. Additionally, once a specific chip has been identified as a failed memory chip, the symbols stored in the memory chip may be marked as erasures (errors whose locations are known) allowing more efficient use of EC symbols, since recovery of corrupt symbols of known locations require fewer (e.g., twice fewer) EC data.

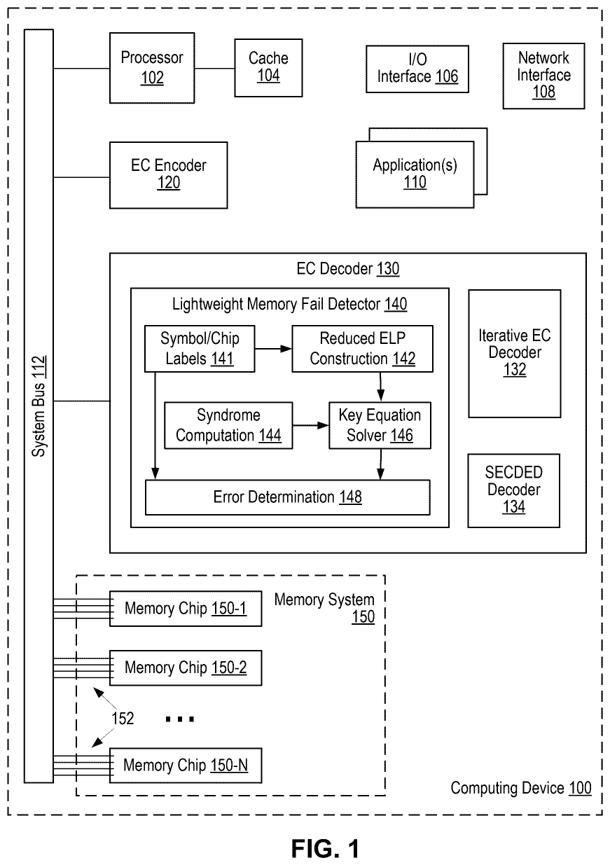

FIG. 1 is a block diagram illustrating an example computing device 100 in which implementations of the present disclosure may operate. Computing device 100 may be any desktop computer, a tablet, a smartphone, a server (local or remote), a thin/lean client device, a server, a cloud computing node, an edge device, a network switch, a gateway device, a card reader, a wireless sensor node, an Internet-of-Things (IoT) node, an embedded system dedicated to one or more specific applications, and so on. Computing device 100 may have one or more processors 102, e.g., central processing units (CPUs), graphics processing units (GPUs), field-programmable gate arrays (FPGA), application-specific integrated circuits (ASICs), and the like. “Processor” refers to a device capable of executing instructions encoding arithmetic, logical, or I/O operations. In one illustrative example, a processor may follow Von Neumann architectural model and may include one or more arithmetic logic units (ALUs), a control unit, and may further have access to a plurality of registers, or a cache 104.

Processor 102 may include one or more processor cores. In implementations, each processor core may execute instructions to run a number of hardware threads, also known as logical processors. Various logical processors (or processor cores) may be assigned to one or more processes supported by processor 102, although more than one processor core (or a logical processor) may be assigned to a single processor for parallel processing. A multi-core processor may simultaneously execute multiple instructions. A single-core processor may typically execute one instruction at a time (or process a single pipeline of instructions).

Computing device 100 may include one or more memory systems 150. The memory system 150 may refer to any volatile or non-volatile memory and may include a read-only memory (ROM), a random-access memory (RAM), electrically erasable programmable read-only memory (EEPROM), flash memory, flip-flop memory, or any other device capable of storing data. RAM may be a dynamic random-access memory (DRAM), synchronous DRAM (SDRAM), a static memory, such as static random-access memory (SRAM), and the like. In some implementations, processor(s) 102 and memory system 150 may be implemented as a single controller, e.g., as an FPGA. Memory system 150 may include multiple memory chips 150-1 . . . 150-N. In some implementations, memory chips 150-1 . . . 150-N which may be accessed via memory channels 152 that allow simultaneous write (store) and read (load) operations, e.g., simultaneous storing and/or reading of multiple data symbols.

Computing device 100 may further include an input/output (I/O) interface 106 to facilitate connection of the computing device 100 to various peripheral hardware devices (not shown in FIG. 1) such as card readers, terminals, printers, scanners, IoT devices, and the like. Computing device 100 may further include a network interface 108 to facilitate connection to a variety of networks (Internet, wireless local area networks (WLAN), personal area networks (PAN), public networks, private networks, etc.), and may include a radio front end module and other devices (amplifiers, digital-to-analog and analog-to-digital converters, dedicated logic units, etc.) to implement data transfer to/from computing device 100. Various hardware components of the computing device 100 may be connected via a system bus 112 that may include its own logic circuits, e.g., a bus interface logic unit (not shown in FIG. 1).

Computing device 100 may support one or more applications 110. Application(s) 110 supported by computing device 100 may include machine-learning application(s), graphics application(s), computational application(s), cryptographic application(s) (such as authentication, encryption, decryption, secure storage application(s), etc.), embedded application(s), external application(s), or any other types of application(s) that may be executed by computing device 100. Application(s) 110 may be instantiated on the same computing device 100, e.g., by an operating system executed by the processor 102 and residing in the memory system 150. Alternatively, the external application(s) may be instantiated by a guest operating system supported by a virtual machine monitor (hypervisor) operating on the computing device 100. In some implementations, the external application(s) may reside on a remote access client device or a remote server (not shown), with the computing device 100 providing computational support for the client device and/or the remote server.

Computing device 100 may include an error correction (EC) encoder 120 that may receive, from processor 102, a data message to be stored in memory system 150. EC encoder 130 may partition the data message into symbols and generate a codeword encoding the data message (e.g., using a generator polynomial, as described above). The codeword may include one or more EC symbols. The codeword encoding the data message may be stored in memory system 150, e.g., in one or more memory chips 150-j.

Computing device 100 may include an EC decoder 130 to perform inverse operations of decoding codewords retrieved from memory system 150. EC decoder may include an iterative EC decoder 132 that may implement various EC techniques and algorithms, e.g., Reed-Solomon codes, Bose-Chaudhuri-Hocquenghem codes, Hamming codes, and the like. EC decoder 130 may further include a Single Error Correction, Double Error Detection (SECDED) decoder 134.

EC decoder 130 may further include a lightweight memory fail detector 140 operating in accordance with various implementations of the instant disclosure. Lightweight memory fail detector 140 may assign and store symbol/chip labels 141 for use in efficient detection of errors confined to specific chips of the memory system 150. For example, each symbol (channel) may be assigned a symbol label α₁, α₂, . . . in a way that results in convenient chip labels β₁, β₂, . . . (e.g., β₁=α₁×α₂×α₃×α₄, etc.). More specifically, the values of chip labels may ensure that reduced error locator polynomials Λ_{R} (x) correspond to errors confined to specific memory chips. Lightweight memory fail detector 140 may use stored symbol/chip labels 141 for reduced ELP construction 142 that may identify a reduced set of error locator polynomials {Λ_{R} (x)}(a subset of all possible error locator polynomials {Λ(x)}) to be used in memory fail detections. A syndrome computation 144 may process the retrieved codeword to generate a syndrome polynomial for the codeword. A key equation solver 146 may use the syndrome polynomial to find a solution of the key equation among the reduced set of error location polynomials {Λ_{R} (x)}. The solution of the key equation may indicate in which memory chip one or more corrupted symbols are stored. The solution of the key equation may be agnostic about how many symbols (one, two, etc.) in the memory chip are corrupted. Lightweight memory fail detector 140 may further include an error determination 148 components that identifies errors (corrupted symbols) within the memory chip and corrects the identified errors.

Any functions or components depicted as part of EC decoder 130 and/or lightweight memory fail detector 140 may be implemented via dedicated hardware circuits configured to perform one or more polynomial operations (e.g., multiplication, addition, inversion, division, differentiation, and the like), or as software modules executed on any suitable processor (e.g., processor 102), or as any combination of dedicated hardware circuits and software modules.

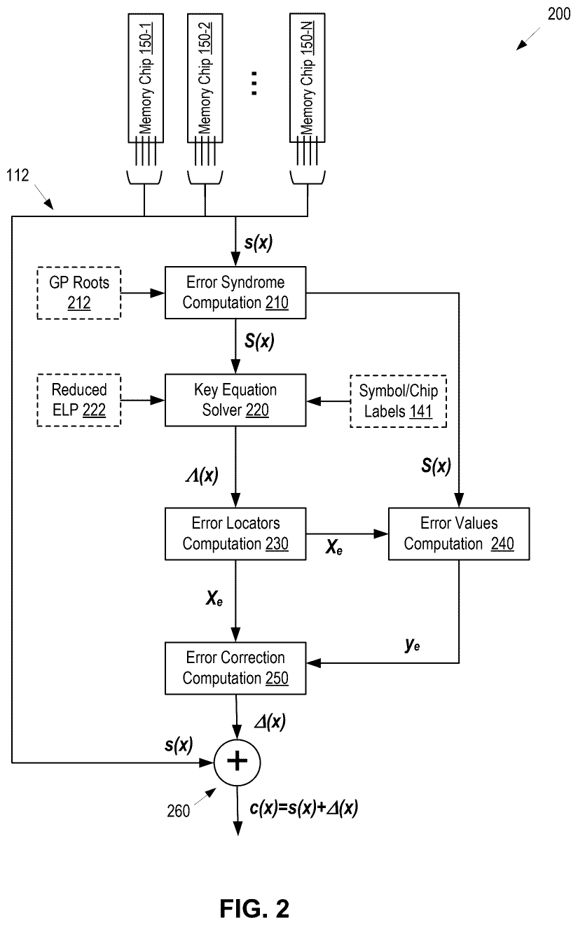

FIG. 2 is a diagram illustrating operations 200 of efficient lightweight detection of memory errors using reduced error locator polynomials, in accordance with some aspects of the present disclosure. In some implementations, operations 200 may be performed by EC decoder 130 of FIG. 1 using hardware circuits and/or software modules described below. Specifically, N memory chips 150-1 . . . 150-N may store a data that includes N×L symbols, L symbols stored per chip. Each symbol may be stored and then retrieved via a separate access channel, for speed of memory operations (writes, reads, erasures, etc.), although this is not a requirement. FIG. 2 illustrates an example of L=4 channels per memory chip, but any other suitable number of symbols may be used to store a codeword of data. A stored codeword of N× L symbols may encode a message that is (N−2)×L+η symbols long, with η symbols over the threshold limit that, given conventional error correction techniques, would need 2L symbols to detect a fail of all L symbols (channels) of any given chip.

As illustrated in FIG. 2, the stored codeword s(x) may be read from the memory chips 150-1 . . . 150-N via bus 112 and one copy of the stored codeword may be input into error syndrome computation 210. Similar to other components of FIG. 2, error syndrome computation 210 may be implemented as a dedicated hardware circuit or as a software function (module) supported by a general-purpose processor (e.g., processor 102 of FIG. 1). Error syndrome computation 210 may treat the stored codeword s(x) as a polynomial of order n−1 whose coefficients are elements of a Galois field GF(2^{q}). For example, each symbol (e.g., 4-bit symbol, 1-byte symbol, 2-byte symbol, etc.) may correspond to a coefficient sⱼ of the respective power j in the polynomial

$$s ( x ) = {\sum }_{j = 0}^{n - 1} {s}_{j} {x}^{j} .$$

Error syndrome computation 210 may have access to roots α₁, α₂ . . . αₜ of a generator polynomial (GP) 212 that was used by EC encoder (e.g., EC encoder 120 of FIG. 1) to generate the codeword. Error syndrome computation 210 may compute the error syndromes Sⱼ=s(aⱼ) for each of the GP roots 212. The error syndromes are the coefficients of the error syndrome polynomial

$$S ( x ) = {\sum }_{j = 0}^{t - 1} {S}_{j + 1} {x}^{j} .$$

Some of the coefficients Sⱼ may be zero. All zero coefficients Sⱼ indicate that no errors have occurred during writing, storage, or retrieval of the codeword.

The error syndrome polynomial S(x) may be provided to a key equation solver (KES) 220. KES 220 may use the error syndrome polynomial to construct and solve the key equation, e.g., equation Ω(x)=Λ(x)S(x) mod x^{t}, where Ω(x) is an error-evaluator polynomial of order that is less than a number v of errors in the codeword. The form of the solution (error locator polynomial or ELP)

$$Λ ( x ) = {\sum }_{l = 0}^{L} {Λ}_{l} {x}^{l}$$

that is used by KES 220 may be limited to a certain subset of polynomials of Lth order. The limited subset of the ELP polynomials (reduced ELP 222) may be configured to detect a limited selection of possible error patterns. For example, the error pattern that is being searched for by KES 220 may include corruption of one or more of (up to all) L symbols of a single memory chip 150-n. For example, reduced ELP 222 may be a single-parameter polynomial, such as Λ_{R}(x) x^{L}+x+β, or Λ_{R}(x)=x^{L}+βx+1, or any other polynomial of practically unlimited number of polynomials of order L having fewer than L degrees of freedom. In some implementations, the reduced ELP 222 has one parameter (as in the above example). In some implementations, the reduced ELP 222 has two (three, etc.) parameters. Additional input into KES 220 may include symbol/chip labels 141, such as symbol labels α₁ . . . αₙ (to be used as error locators) for various symbols and chip labels β₁ . . . β_{N} for various memory chips.

In some implementations, the error pattern that is being searched for by KES 220 may include corruption of multiple memory chips, with the reduced ELP 222 being a product of two single-chip polynomials, e.g., Λ_{R}(x)=(x^{L}+x+β)×(x^{L}+x+β̅), in which β and β̅ are chip labels of two memory chips. Such reduced ELP may be capable of detecting one or more corrupted symbols distributed in any way among the corresponding two memory chips but may be agnostic as to the number of corrupted symbols and distribution of the corrupted symbols across the two memory chips.

In one non-limiting example of four symbols per chip, L=4, four symbols stored in a specific chip may be assigned labels that are given by α₁=d⁻¹, α₂=(d+1)⁻¹, α₃=(d+z)⁻¹, and α₄=(d+z+1)⁻¹, where d and z are some elements of a Galois field GF(2ⁿ), with n≥2. As can be readily verified, the corresponding reduced

$$ELP , {Λ}_{R} ( x ) = {\prod }_{e = 1}^{4} ( 1 - x {α}_{e} )$$

then amounts to (up to an irrelevant overall scaling constant) Λ_{R}(x)=x⁴+x+β, provided that z satisfies the Golden Ratio quadratic equation, z²+z=1. The free parameter β characterizes the chip as a whole and is determined by the individual symbol labels, β=(α₁α₂α₃α₄)⁻¹=d(d+1)(d²+1). Each symbol may be assigned a unique label αₑ and each chip may have a unique label βᵢ. In some implementations, chip labels βᵢ may be confined to a subfield of the Galois field. This simplifies the solution process of the key equation, shortens its duration, and reduces the size of the hardware circuits (e.g., KES 220). For example, the symbols may be elements of the Galois field GF(2⁸) whereas chip labels βᵢ may be confined to the Galois field GF(2⁴).

In some implementations, the key equation Ω(x)=Λ(x)S(x) mod x^{t} may be solved by a direct division of two polynomials. For example, for reduced polynomials of the form, Λ_{R}(x) x^{L}+x+β, the solution may be obtained by dividing the polynomial (x^{L}+x)·S(x) by S(x) and requiring that the top coefficients of the resulting polynomial be zero. In those instances where a compound failure of up to L symbols stored in any of the N chips occurs, the solution of the key equation by KES 220 yields the ELP of the reduced form Λ_{R}(x) with the parameter β equal to one of the chip labels β₁ . . . β_{N}, associated with a respective chip. Accordingly, if the reduced ELP Λ_{R}(x) associated with a particular subset of memory failures (e.g., failures confined within a single chip) indeed provides a solution to the key equation, the remaining degree(s) of freedom determined by KES 220 in the course of solving the key equation identify the chip in which the errors occur. In the instances where the reduced ELP Λ_{R}(x) does not provide a valid solution of the key-equation with the parameter β equal to one of the chip labels β₁ . . . β_{N}, the errors are not confined to a single chip.

In the instances where KES 220 is successful in finding a solution using the reduced ELP, the obtained ELP Λ_{R}(x) may be provided to error locator computation 230 that may determine specific labels Xₑ, of the subset of symbol labels αₑ associated with the obtained ELP Λ_{R}(x), and identify corrupted symbols. For example, error locator computation 230 may determine that corrupted symbols are symbols #1 and #3 of chip #6 whose label β₆ was determined by KES 220. In some implementations, error locator computation 230 may be performed by (or as part of) iterative EC decoder 132. In some implementations, error locator computation 230 may initially assume corruption of all symbols in chip j where errors are located. The error values computation 240 may then compute error values yₑ (e.g., using the Forney algorithm) in each symbol location. In those instances where one or more the symbols of chip j are error-free, the error values computation 240 may return zero error values yₑ=0. In some implementations, the roots

$${X}_{e}^{- 1}$$

of the (full) ELP

$$Λ ( x ) = {\prod }_{e = 1}^{v} ( 1 - {xX}_{e} )$$

can be found, e.g., by an exhaustive search. For example, having determined that one or more errors are confined to chip j, error locator computation 230 may try, consecutively, L candidate ELPs Λᵥ₌₁=1−xXₑ with one error in the chip; then try L!/[(L−2)!2] candidate ELPs Λᵥ₌₂=(1−xXₑ)(1−xXₑ′) with two errors in the chip, and so on, until an ELP is found that satisfies the key equation. Since KES 220 has determined, using the reduced ELP Λ_{R}(x), the chip storing the corrupted data, and hence narrowed down the number of possible corrupted symbols to at most L, the exhaustive search may be performed quickly. If error locator computation 230 determines that more than L−1 errors have occurred in the chip (whereas KES 220 has made the determination that errors are confined to a single chip), it then follows that all symbols (channels) of the chip have been corrupted. This may indicate a suspected chip failure, which may be confirmed when a certain minimum number of repeated occurrences of all L symbols read from the same chip is detected.

The error locators {Xₑ} computed as the reciprocals of the roots

$$\{ {X}_{e}^{- 1} \}$$

of the ELP may be provided to error values computation 240 that computes error values yₑ, e.g., by solving the system of equations,

$${S}_{j} = {\sum }_{e = 1}^{v} {y}_{e} {X}_{e}^{j} ,$$

which may be performed using the Forney algorithm or some other algorithm for solving a system of linear equations. In some implementations, the error values yₑ may be computed using the ratio of the error-evaluator polynomial computed at the corresponding error locator Xₑ to the derivative of the ELP at the same point, Ω(Xₑ)/Λ′(Xₑ). The advantages of the reduced ELPs (e.g., Λ_{R}(x)=x^{L}+x+β) include a simple form of the derivative, which for even L may simply reduce to a constant value (e.g., 1, in this example). Error correction computation 250 may then use the obtained error locators {Xₑ} and error values {yₑ} to determine the error polynomial, Δ(x). The error polynomial Δ(x) may be added by an adder circuit 260 (e.g., a bitwise XOR circuit) to obtain the actual codeword, c(x)=s(x)+Δ(x).

Any of the components 210-260 may be implemented using dedicated hardware circuits. In some implementations, the functions of some or all of the components 210-260 may be implemented using software modules and processes executed by a general-purpose processor, e.g., a CPU, FPGA, ASIC, and the like.

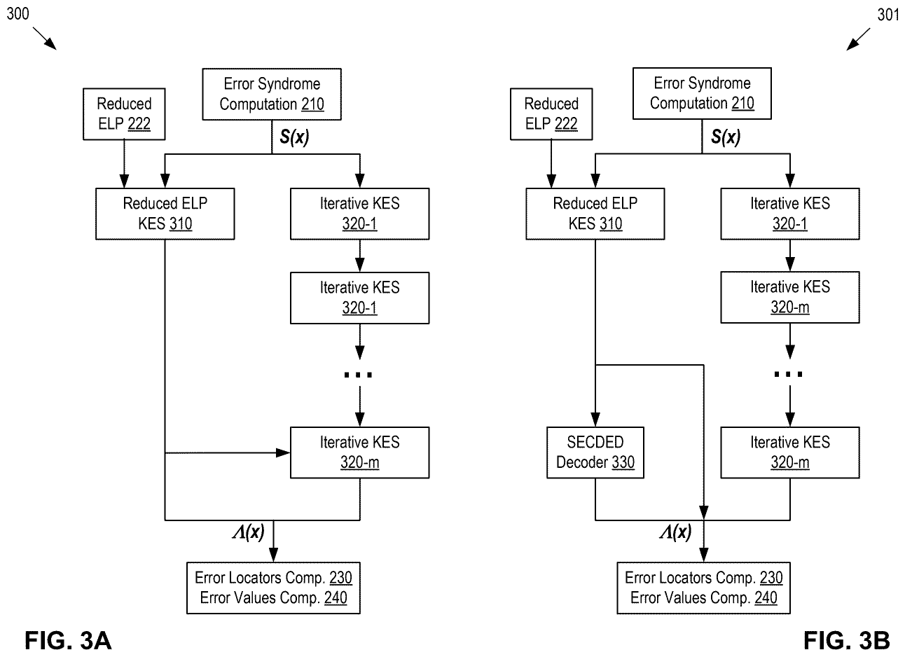

FIGS. 3A-B are diagrams illustrating operations of key equation solvers that implement lightweight detection of memory fails, in accordance with some aspects of the present disclosure. As depicted in FIG. 3A, key equation solver 300 may process error syndrome polynomial S(x) using two branches. A first branch may deploy a reduced ELP KES 310, operating as described above in conjunction with FIG. 2. A second branch may include a conventional iterative solution of the key equation, which may be performed using multiple iterative KES 320-1, 320-2, . . . 320-m. In some implementations, the first branch and the second branch may be performed in parallel using separate hardware circuits.

In some implementations, the iterative branch may use the Berlekamp-Massey algorithm, the Sarwate-Shanbhag algorithm, or any other suitable iterative solution of the key equation. More specifically, an iterative algorithm may start with a seed ELP having no roots, e.g., Λ₀(x)=1. The first iterative KES 320-1 may then use the first coefficient S₁ of the syndrome polynomial as an input and determine how the ELP should be modified, Λ₀(x)→Λ₁(x), to ensure that the modified ELP is consistent with St. Each subsequent iterative KES 320-j repeats the same process, e.g., taking jth coefficient Sⱼ of the syndrome polynomial S(x) as an input and determining how the accumulated ELP should be updated, Λⱼ₋₁(x)→Λⱼ(x) to ensure that the updated ELP is consistent with all coefficients evaluated so far, S₁ . . . Sⱼ. In some implementations, the number of iterative KES stages may be the same as the number of EC symbols, m=2L−η.

For sub-threshold error correction (η>0), the number of EC symbols (and, respectively, the number of coefficients Sⱼ of the syndrome polynomial) may be less than is sufficient (e.g., 2L) to locate and correct L errors. Unlike existing sub-threshold algorithms (e.g., Sudan-Guruswami algorithm) that consider all remaining possibilities for the ELP in lieu of the missing number pf η coefficients of the syndrome polynomial (which is a slow procedure), the implementation illustrated in FIG. 3A takes advantage of the reduced ELP polynomial output by reduced ELP KES 310. For example, the reduced ELP polynomial may have zero coefficients of some powers of x, e.g., x³, x², and so on. A discrepancy (e.g., non-zero value) in such coefficients of the current ELP obtained after 2L−η iterations may be used as a replacement of the missing coefficient(s) S_{2L-η+1} . . . S_{2L}. The final value of the ELP is then adjusted to remove the existing discrepancies while still being consistent with the previously evaluated coefficients S₁ . . . S_{2L-η}. The obtained ELP may then be used for error locator computation 230 and error values computation 240, in accordance with any known techniques.

The key equation solver 300 of FIG. 3A may also be used in situations where a chip failure has been detected, but the system has not been shut down yet. For example, memory fails of all L channels of a particular memory chip may have been detected (as described above) over multiple (two or more) data retrievals. The memory system may then be operated in a quarantine mode where chip errors are treated as erasures at known locations (all L symbols of the failed chip). Erasures are treated as symbols that cannot be recognized and may require fewer EC symbols for their correction (for example, two times fewer EC symbols compared with correction of symbols at unknown locations). In some implementations, the available EC symbols may be used to identify locations and correct up to 2L−η (the total number of EC symbols) minus L (the number of known erasures associated with the failed chip) and divided by 2 (the number of symbols needed for correction of each unknown error). Accordingly, up to (L−η)/2 additional errors (or the nearest integer rounded down from (L−η)/2) in the remaining memory chips can be corrected. For example, if L=4 and η=1, one additional error may be located and corrected outside the failed chip. In particular, as depicted in FIG. 3A, after the processing of the ELP using the reduced ELP KES 310, the output may be provided to the back of the iterative branch for the last (L−η)/2 iterations. FIG. 3B, depicts another implementation of the key equation solver 301, in which the last iteration is performed by a separate Single Error Correction, Double Error Detection (SECDED) decoder 330.

During operations described above in relation to FIG. 3A and/or FIG. 3B, the reduced ELP KES 310 may continue monitoring the failed memory chip, e.g., by confirming that successive data retrievals remain consistent with the reduced ELP polynomial Λ_{R}(x) in which a chip label β is still the label of the failed chip. In the instances of a spontaneous recovery of the failed chip, the reduced ELP KES 310 may detect that the reduced ELP polynomial Λ_{R} (x) with the chip label β has stopped providing a valid solution of the key equation. In the meantime, the iterative KES pipeline 320-1 . . . 320-m may detect no further errors in the chip previously marked as failed. In response to such findings of the reduced ELP KES 310 and/or the iterative KES pipeline 320-1 . . . 320-m, the quarantine mode can be exited, e.g., after a predetermined threshold number of error-free memory read operations from the chip. The normal memory operations may then be resumed.

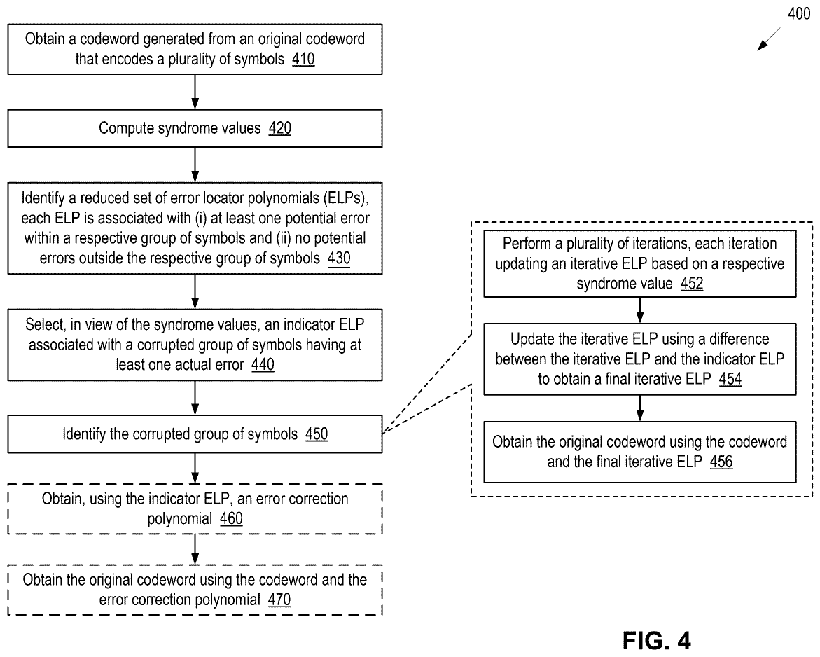

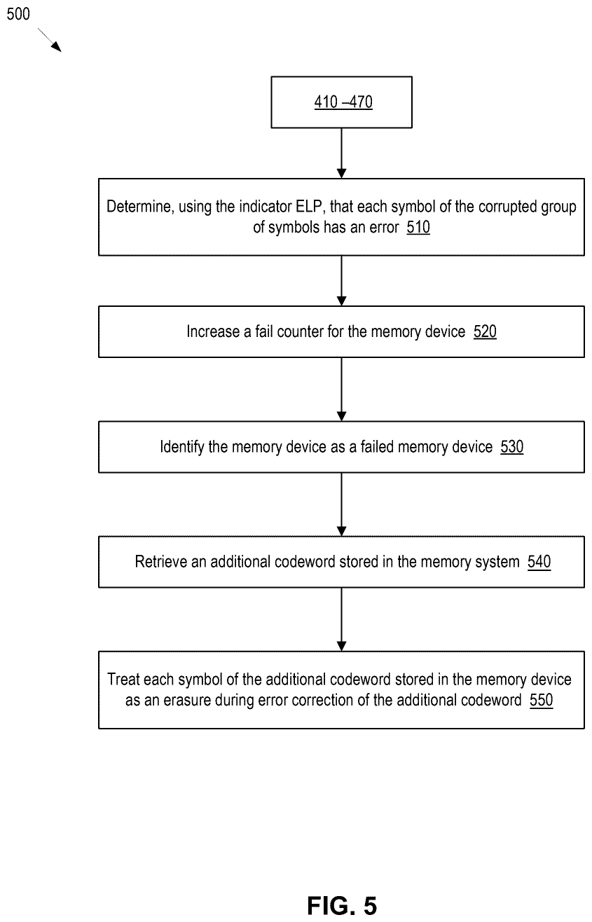

FIGS. 4-5 illustrate example methods 400 and 500 that can be used for error detection and correction using limited error correction symbols. Methods 400 and 500 and each of their individual functions, routines, subroutines, and/or operations may be performed by an error correction engine, such as EC decoder 130 in FIG. 1 having dedicated circuits, or a general-purpose processor, such as processor 102 depicted in FIG. 1. Various blocks of methods 400 and 500 may be performed in a different order compared with the order shown in FIG. 4 and FIG. 5. Some blocks may be performed concurrently with other blocks. Some blocks may be optional. Methods 400 and 500 may be implemented as part of data write and read operations or as part of a network data communication operation. In certain implementations, a single processing thread may perform methods 400 and 500. Alternatively, two or more processing threads may perform methods 400 and 500, each thread executing one or more individual functions, routines, subroutines, or operations of the methods. In an illustrative example, the processing threads implementing methods 400 and 500 may be synchronized (e.g., using semaphores, critical sections, and/or other thread synchronization mechanisms). Alternatively, the processing threads implementing methods 400 and 500 may be executed asynchronously with respect to each other. Various operations of each of methods 400 and 500 may be performed in a different order compared with the order shown in FIGS. 4-5. Some operations of each of methods 400 and 500 may be performed concurrently with other operations. Some operations may be optional.

FIG. 4 is a flow diagram illustrating an example method 400 of efficient lightweight detection of memory errors using reduced error locator polynomials, in accordance with some implementations of the present disclosure. At block 410, processing units performing method 400 may obtain a codeword generated by a computer operation applied to an original codeword. The original codeword may encode a plurality of multi-bit symbols, e.g., 4-bit symbols, 1-byte symbols, and so on. In some implementations, the computer operation may include storing the original codeword in a memory system and reading the codeword from the memory system. The obtained codeword may be different from the original codeword because of corruption (occurrence of errors) of some of the symbols. In some implementations, the computer operation may include transmitting the original codeword over a network (or a bus) by a first computing device and receiving the codeword by a second computing device. The received codeword may be different from the transmitted codeword because of noisy network transmission causing some symbols to be lost or altered. In some implementations, the plurality of symbols of the original codeword (e.g., n symbols) includes a number of error correction (EC) symbols (e.g., n−k EC symbols). In some implementations, the number of EC symbols is less (n−k<2L) than twice a number (L) of symbols in each group of symbols of the plurality of groups of symbols. In some implementations, each group of symbols of the plurality of groups of symbols is stored in a respective memory device of a plurality of memory devices of the memory system. For example, each memory device (e.g., separate memory chip of the memory system) may store L symbols of the codeword.

“Memory system” should be understood as any system capable of storing non-transitory data. “Memory system” may comprise any number of memory devices. “Memory device” should be understood as any part of the memory system, such as a separate memory chip, a separate physical partition of a memory chip, a logical partition, and so on.

At block 420, method 400 may continue with the processing units computing, using the obtained (e.g. retrieved from the memory or received over the network) codeword, a plurality of syndrome values (e.g., n−k values Sⱼ, as described above) characterizing a difference between the codeword and the original codeword.

At block 430, method 400 may continue with the processing units identifying a reduced set of error locator polynomials (ELPs) for the codeword. Each ELP of the reduced set of ELPs may be associated with (i) at least one potential error within a respective group of symbols of a plurality of groups of symbols of the codeword and (ii) absence of potential errors outside the respective group of symbols. In one illustrative non-limited example, the reduced set of ELPs may be a set of polynomials Λ_{R}(x;βᵢ)=x^{L}+x+βᵢ with different values βᵢ. The polynomial Λ_{R}(x;βᵢ) may be associated with potential errors within the i-th group of symbols (e.g., the i-th memory chip or a group of symbols transmitted over the i-th network channel) and also associated with the absence of potential errors in other groups of symbols. Each polynomial of the reduced set of ELPs (e.g., Λ_{R} (x;βᵢ)) may be agnostic about a number of potential errors within the respective group of symbols of the plurality of groups of symbols. More specifically, each polynomial of the reduced set of ELPs may be a solution of the key equation for any number of corrupted symbols in the respective group, ranging from one symbol to all symbols in the group.

In some implementations, each ELP of the reduced set of ELPs has an order that is equal to the number of symbols (e.g., L) in each group of symbols of the plurality of groups of symbols. In some implementations, the reduced set of ELPs may be a subset of polynomials of an order that is equal to a number of symbols in each group of symbols, with one or more coefficients of the reduced set of ELPs belonging to a group of elements consisting of a zero element and a unity element. For example, for L=4, the reduced set of polynomials Λ_{R} (x;βᵢ)=x⁴+x+βᵢ has the zero element as coefficients of the x³ term and the x² term and the unity element as the coefficient of the x term. In some implementations, each symbol of the plurality of symbols may be an element of a Galois Field GF(2^{q}) having 2^{q} elements while coefficients of each ELP of the reduced set of ELPs belong to a subset of the Galois Field GF(2^{q}), such as the Galois Field GF(2^{P}) with p<q. For example, the coefficients (e.g., 0, 1, βᵢ) of the polynomials Λ_{R} (x;βᵢ)=x⁴+x+βᵢ may belong to the Galois Field GF(2⁴).

At block 440, method 400 may continue with the processing units selecting, in view of the plurality of syndrome values, an indicator ELP from the reduced set of ELPs, wherein the indicator ELP is associated with a corrupted group of symbols of the plurality of groups of symbols, the corrupted group of symbols having at least one error. For example, the processing units may determine, in the course of solving the key equation, that a particular ELP, e.g., Λ_{R} (x;β₁) of the reduced set of ELPs {Λ_{R} (x;βᵢ)} indeed satisfies the key equation. Correspondingly, at block 450, the processing units may identify, using the indicator ELP, e.g., Λ_{R}(x;β₁), the corrupted group of symbols (e.g., the group of symbols associated with group (chip) label β₁.

In some implementations, identifying, using the indicator ELP, the corrupted group of symbols may further include identifying one or more specific symbols of the group that are corrupted. “Corrupted group” should be understood as a group of symbols that has at least one corrupted symbol but may include any number of uncorrupted symbols. For example, as illustrated with the callout portion of FIG. 4, the processing units performing method 400 may, at block 452, perform a plurality of iterations, wherein each iteration may update an iterative ELP based on a respective syndrome value of the plurality of syndrome values. More specifically, a j-th iteration (of n−k total iterations) may update the iterative ELP in such a way that the updated iterative ELP represents the solution of the key equation with syndrome values S₁ . . . Sⱼ. At block 454, the processing units may further updating the iterative ELP (e.g., obtained after all n−k iterations), using a difference between the iterative ELP and the indicator ELP, to obtain a final iterative ELP. At block 456, method 400 may include obtaining the original codeword using the codeword and the final iterative ELP.

In some implementations, obtaining the original codeword may include operations of blocks 460 and 470. For example, at block 460, the processing units performing method 400 may obtain, using the indicator ELP, an error correction polynomial representing the difference between the (retrieved or received) codeword and the original (stored or transmitted) codeword. More specifically, the obtained ELP (e.g., the final iterative ELP) may be used to determine error locators and error values and construct the error polynomial. At block 470, method 400 may include obtaining the original codeword using the codeword and the error correction polynomial Δ(x). For example, the processing units may add (e.g., using XOR addition) the error correction polynomial Δ(x) to the codeword s(x) to recover the value of the original codeword c(x).

In some implementations, various blocks of method 400 may be performed by different processing circuits. For example blocks 410 and 420 may be performed by a first set of (one or more) processing circuits, e.g., a memory access circuit and error syndrome computation 220 circuit (as shown in FIG. 2), blocks 430 and 440 may be performed by a second set of (one or more) processing circuits, e.g., by reduced KES 310 (as shown in FIG. 3). Blocks 450-470 may be performed by a third set of (one or more) processing circuits, e.g., by iterative KES 320-1 . . . 320-m circuits, error locators computation 230 circuit, error values computation 240 circuit, error correction computation 250 circuit, and the like.

FIG. 5 is a flow diagram illustrating an example method 500 of detecting and managing failed memory devices, in accordance with some implementations of the present disclosure. At block 510, processing units performing method 500 may include determining, using the indicator ELP, that each symbol of the corrupted group of symbols has an error. At block 520, responsive to identifying that the corrupted group of symbols is stored in a given memory device of the plurality of memory devices, method 500 may continue with increasing a fail counter for the given memory device. For example, each memory device (e.g., individual memory chip) may have a separate fail counter that counts the number of errors in symbols retrieved from the corresponding memory device.

At block 530, responsive to the fail counter reaching a threshold value, method 500 may continue with identifying the given memory device as a failed memory device. The threshold value may be a number of consecutive times that all symbols in the given memory device have been corrupted. In some implementations, the threshold value may be a number of consecutive times that at least a predetermined number of symbols (e.g., two out of four symbols, etc.) in the given memory device have been corrupted. In some implementations, the threshold value may be a percentage of corrupted symbols over a predetermined number of the most recent data reads.

At block 540, method 500 may continue with the processing units retrieving an additional codeword stored in the memory system. The additional codeword may be a subsequent memory read performed after the given memory device has been identified as a failed memory device. At block 550, responsive to identifying that the given memory device is a failed memory device, method 500 may continue with treating each symbol of the additional codeword stored in the given memory device as an erasure during error correction of the additional codeword. In those instances where the errors in symbols retrieved from the memory device previously identified as a failed memory device spontaneously cease to occur, the memory device may be reclassified as a normal memory device with the symbols retrieved from the memory device no longer considered as erasures.

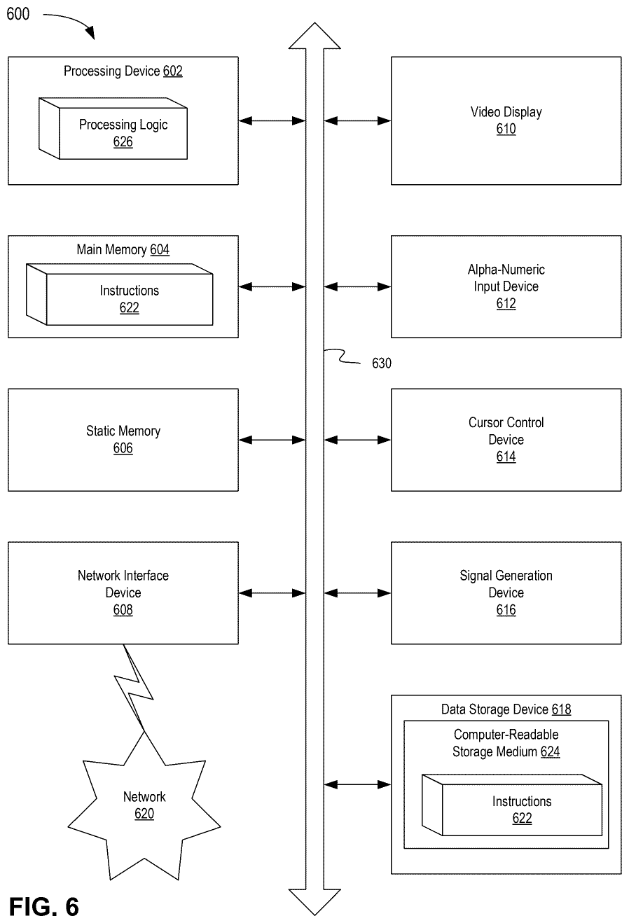

FIG. 6 depicts an example computer system 600 that can perform any one or more of the methods described herein, in accordance with some implementations of the present disclosure. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a set-top box (STB), a Personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The exemplary computer system 600 includes a processing device 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)), and a data storage device 618, which communicate with each other via a bus 630.

Processing device 602 (which can include processing logic 626) represents one or more general-purpose processing devices such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also be one or more special-purpose processing devices such as an application specific integrated circuit (ASIC), a field programmable gate array (FPGA), a digital signal processor (DSP), network processor, or the like. The processing device 602 is configured to execute instructions 622 for implementing EC encoder 120 and EC decoder 130 of FIG. 1 and to perform the operations discussed herein (e.g., methods 400 and 500 of FIGS. 4-5).

The computer system 600 may further include a network interface device 608. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 616 (e.g., a speaker). In one illustrative example, the video display unit 610, the alphanumeric input device 612, and the cursor control device 614 may be combined into a single component or device (e.g., an LCD touch screen).

The data storage device 618 may include a computer-readable storage medium 624 on which is stored the instructions 622 embodying any one or more of the methodologies or functions described herein. The instructions 622 may also reside, completely or at least partially, within the main memory 604 and/or within the processing device 602 during execution thereof by the computer system 600, the main memory 604 and the processing device 602 also constituting computer-readable media. In some implementations, the instructions 622 may further be transmitted or received over a network via the network interface device 608.

While the computer-readable storage medium 624 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operations may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “analyzing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. Furthermore, the terms “first,” “second,” “third,” “fourth,” etc. as used herein are meant as labels to distinguish among different elements and may not necessarily have an ordinal meaning according to their numerical designation.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

What is claimed is:

1. A method comprising:
obtaining a codeword generated by a computer operation applied to an original codeword, wherein the original codeword encodes a plurality of symbols;
computing, using the codeword, a plurality of syndrome values characterizing a difference between the codeword and the original codeword;
identifying a reduced set of error locator polynomials (ELPs) for the codeword, wherein each ELP of the reduced set of ELPs is associated with (i) at least one potential error within a respective group of symbols of a plurality of groups of symbols of the codeword and (ii) absence of potential errors outside the respective group of symbols;
selecting, in view of the plurality of syndrome values, an indicator ELP from the reduced set of ELPs, wherein the indicator ELP is associated with a corrupted group of symbols of the plurality of groups of symbols, the corrupted group of symbols having at least one error; and
identifying, using the indicator ELP, the corrupted group of symbols.

2. The method of claim 1, wherein the computer operation comprises storing the original codeword in a memory system and reading the codeword from the memory system.

3. The method of claim 2, wherein each group of symbols of the plurality of groups of symbols is stored in a respective memory device of a plurality of memory devices of the memory system.

4. The method of claim 3, further comprising:
determining, using the indicator ELP, that each symbol of the corrupted group of symbols has an error;
responsive to identifying that the corrupted group of symbols is stored in a given memory device of the plurality of memory devices, increasing a fail counter for the given memory device; and
responsive to the fail counter reaching a threshold value, identifying the given memory device as a failed memory device.

5. The method of claim 4, further comprising:
retrieving an additional codeword stored in the memory system; and
responsive to identifying that the given memory device is a failed memory device, treating each symbol of the additional codeword stored in the given memory device as an erasure during error correction of the additional codeword.

6. The method of claim 1, wherein the plurality of symbols of the original codeword comprises a number of error correction (EC) symbols, and wherein the number of EC symbols is less than twice a number of symbols in each group of symbols of the plurality of groups of symbols.

7. The method of claim 1, wherein each ELP of the reduced set of ELPs is agnostic about a number of potential errors within the respective group of symbols of the plurality of groups of symbols.

8. The method of claim 1, wherein each ELP of the reduced set of ELPs has an order that is equal to a number of symbols in each group of symbols of the plurality of groups of symbols.

9. The method of claim 1, wherein the reduced set of ELPs is a subset of polynomials of an order that is equal to a number of symbols in each group of symbols, and wherein one or more coefficients of the reduced set of ELPs belong to a group of elements consisting of a zero element and a unity element.

10. The method of claim 1, wherein each symbol of the plurality of symbols is an element of a Galois Field GF(2^{q}) comprising 2^{q} elements, wherein coefficients of each ELP of the reduced set of ELPs belong to a subset of the Galois Field GF(2^{q}), wherein the subset is a Galois Field GF(2^{P}) with p<q.

11. The method of claim 1, further comprising:
obtaining, using the indicator ELP, an error correction polynomial representing the difference between the codeword and the original codeword; and
obtaining the original codeword using the codeword and the error correction polynomial.

12. The method of claim 1, wherein identifying, using the indicator ELP, the corrupted group of symbols comprises:
performing a plurality of iterations, wherein each iteration updates an iterative ELP based on a respective syndrome value of the plurality of syndrome values;
updating the iterative ELP, obtained after the plurality of iterations, using a difference between the iterative ELP and the indicator ELP, to obtain a final iterative ELP; and
obtaining the original codeword using the codeword and the final iterative ELP.

13. A system comprising:
a memory system; and
one or more processing units operatively coupled to the memory system, the one or more processing units to:
obtain a codeword generated by a computer operation applied to an original codeword, wherein the original codeword encodes a plurality of symbols;
compute, using the codeword, a plurality of syndrome values characterizing a difference between the codeword and the original codeword;
identify a reduced set of error locator polynomials (ELPs) for the codeword, wherein each ELP of the reduced set of ELPs is associated with (i) at least one potential error within a respective group of symbols of a plurality of groups of symbols of the codeword and (ii) absence of potential errors outside the respective group of symbols;
select, in view of the plurality of syndrome values, an indicator ELP from the reduced set of ELPs, wherein the indicator ELP is associated with a corrupted group of symbols of the plurality of groups of symbols, the corrupted group of symbols having at least one error; and
identify, using the indicator ELP, the corrupted group of symbols.

14. The system of claim 13, wherein the computer operation comprises storing the original codeword in a memory system and reading the codeword from the memory system, wherein
each group of symbols of the plurality of groups of symbols is stored in a respective memory device of a plurality of memory devices of the memory system.

15. The system of claim 14, wherein the one or more processing units are further to:
determine, using the indicator ELP, that each symbol of the corrupted group of symbols has an error;
responsive to identifying that the corrupted group of symbols is stored in a given memory device of the plurality of memory devices, increase a fail counter for the given memory device; and
responsive to the fail counter reaching a threshold value, identify the given memory device as a failed memory device.

16. The system of claim 15, wherein the one or more processing units are further to:
retrieve an additional codeword stored in the memory system;
responsive to identifying that the given memory device is a failed memory device, treat each symbol of the additional codeword stored in the given memory device as an erasure during error correction of the additional codeword.

17. The system of claim 13, wherein the one or more processing units are further to:
obtain, using the indicator ELP, an error correction polynomial representing the difference between the codeword and the original codeword; and
obtain the original codeword using the codeword and the error correction polynomial.

18. The system of claim 13, wherein to identify, using the indicator ELP, the corrupted group of symbols, the one or more processing units further to:
perform a plurality of iterations, wherein each iteration updates an iterative ELP based on a respective syndrome value of the plurality of syndrome values;
update the iterative ELP, obtained after the plurality of iterations, using a difference between the iterative ELP and the indicator ELP, to obtain a final iterative ELP; and
obtain the original codeword using the codeword and the final iterative ELP.

19. The system of claim 13, wherein each ELP of the reduced set of ELPs is agnostic about a number of potential errors within the respective group of symbols of the plurality of groups of symbols.

20. A system comprising:
a plurality of memory devices;
a first set of one or more processing circuits to:
receive, from the plurality of memory devices, a codeword comprising a plurality of symbols, wherein each of the plurality of symbols is received from a corresponding memory device of the plurality of memory devices, and wherein the codeword has at least one error relative to an original codeword stored in the plurality of memory devices; and
compute, using the codeword, a plurality of syndrome values characterizing a difference between the codeword and the original codeword;
a second set of one or more processing circuits to:
identify a reduced set of error locator polynomials (ELPs) for the codeword, wherein each ELP of the reduced set of ELPs is associated with (i) at least one potential error within a respective group of symbols of a plurality of groups of symbols of the codeword and (ii) absence of potential errors outside the respective group of symbols; and
select, in view of the plurality of syndrome values, an indicator ELP from the reduced set of ELPs, wherein the indicator ELP is associated with a corrupted group of symbols of the plurality of groups of symbols, the corrupted group of symbols having at least one error; and
a third set of one or more processing circuits to:
perform a plurality of iterations, wherein each iteration updates an iterative ELP based on a respective syndrome value of the plurality of syndrome values;
update the iterative ELP, obtained after the plurality of iterations, using a difference between the iterative ELP and the indicator ELP, to obtain a final iterative ELP; and
obtain the original codeword using the codeword and the final iterative ELP.
